(19) United States
(12) Patent Application Publication
(10) Pub. No.: US 2007/0209014 A1
(43) Pub. Date: Sep. 6, 2007

(54) Method and apparatus for secure data input

(75) Inventor: Youssef Youmtoub, Jerusalem (IL)

Correspondence Address: Youssef Youmtoub, c/o Mellissa Lau, 763 St. Francis Blv, Daly City, CA, 94015, US

(73) Assignee: youssef youmtoub

(21) Appl. No.: 11/306,774

(22) Filed: Jan. 11, 2006

(51) Int. Cl. G06F 3/048; H04L 9/00

(52) U.S. Cl. 715/771; 713/182

(57) ABSTRACT

The invention provides a method for providing, a user to securely input sensitive data such as user name, password or other sensitive data such as trade secrets or social security number into a computing device such as computer system or website or any device that may require sensitive data to be input, there are hundreds of prior inventions that deal with data security and computer security but they all deal with the data security once it has been input and often by that time it is already too late because sensitive data has already been compromised by something like a simple key-logging device or in the case of voice recognition the data could have been intercepted with a simple recording device this invention allows for securely inputting the data and can be then coupled if desired with other inventions that deal with data and computer security after the data has been input into the system.

Virtually all major banks, brokerage firms, and web sites like paypal, elance and others require the user to input their personal information, including choosing log-in and password as well as such sensitive information as Social Security number. There is an urgent need for being able to securely log into a website and also to be able to input the information safely and securely minimizing the ability for hackers to obtain your personal information with simple devices such as key stroke loggers and other invasive technologies.

### BACKGROUND OF THE INVENTION

1. Field of the Invention

This invention relates to providing a system and method to securely input data into a computing system or equipment that has data input capability and protecting said systems and data from unauthorized users.

2. Description of the Background Art

All the prior art relating to computer, web, network, or device security has all dealt with security after the data has been inputted into the system which in many cases is already too late and can be defeated with a simple and easy to obtain piece of software called a key-stroke logger that will record all key strokes from a users keyboard. No matter how complicated and secure they make the computers with all the different encrypting and firewall devices that secure computers and websites are installing with the prior art none secure the data as it is being inputted as this invention does. Following are some examples of such systems:

Prior art system, disclosed in U.S. Pat. No. 5,150,407 issued to Steve Chan on Sep. 22, 1992, is directed to a secured data storage device employing different levels of security and limiting access from outside sources. The medium portion includes a conventional storage medium such as a hard disk or a floppy disk. In this system, data is secured by utilizing an encryption algorithm and the associated key is separated into two parts, wherein the parts are stored in different drives.

Another prior art system, disclosed in U.S. Pat. No. 5,289,540 issued to Richard Jones on Feb. 22, 1994, is directed to a computer file protection system. The method includes hardware and software elements and the process works by intercepting the file system data path between a central processing unit and a file storage or memory device. The method also includes a programmable memory and auxiliary device.

Another prior art system, disclosed in U.S. Pat. No. 5,623,546 issued to Douglas Hardy, et al., on Apr. 22, 1997, is directed to an encryption method and system for portable data, wherein portable encrypted data can be accessed through multiple hosts. A split key encryption system encrypts data and stores that data on a portable device. One split of the portable key is stored in the portable device, and another split of the key is stored in the home host.

None of the above prior art deals with securing the data while it is being input into the system.

### BRIEF DESCRIPTION OF ART

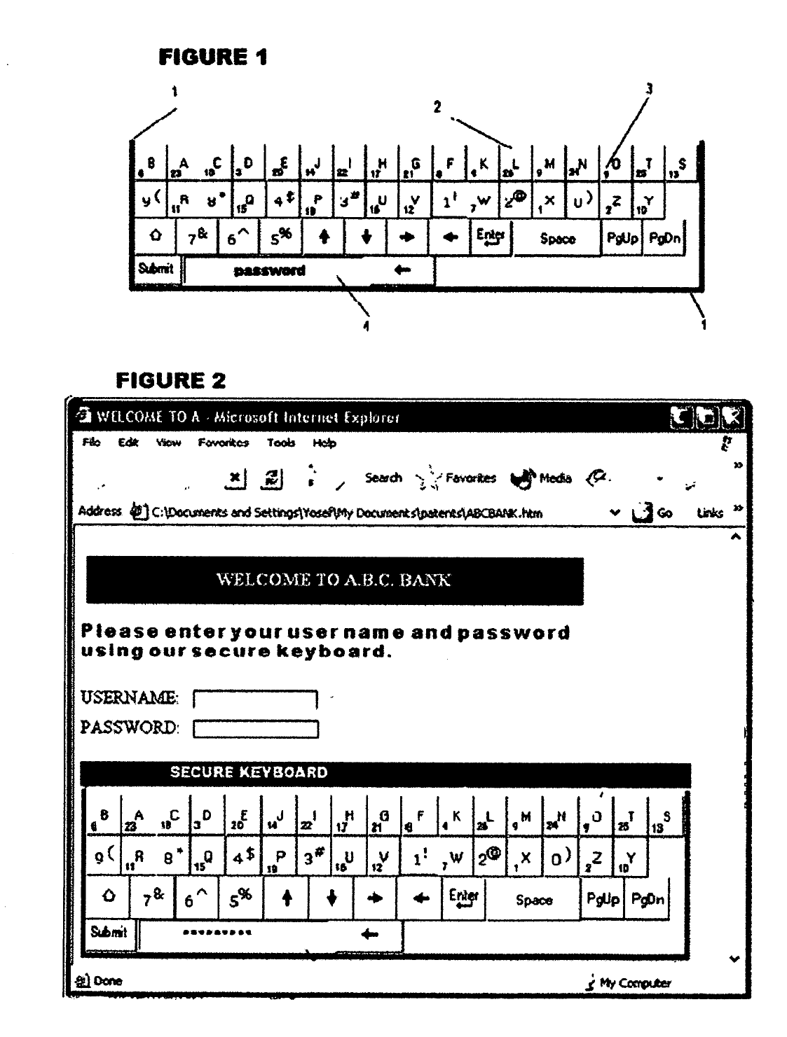

FIG. 1: shows an example of a virtual input device:
1. Element 1 shows an example embodiment of the virtual input device
2. Element 2 shows a character key
3. Element 3 shows an example of a possible corresponding key symbol
4. Element 4 shows an example of a possible input entry display

FIG. 2: shows an example website embodiment of the invention.

### DESCRIPTION OF THE PREFERRED EMBODIMENTS

The preferred embodiments of the invention are varied but can be immediately implemented to provide enhanced security to bank websites or other financially related secure website that are losing millions due to access by unauthorized users who gain password or other sensitive data at the time the information is input.

Further this system can be used to protect critical equipment such as machinery or systems from unauthorized use and employing this method to enhance input security to those systems thereby enhancing access security by preventing unauthorized users from obtaining the data needed to access the system at the time it is input.

As voice recognition increases technology increases a system for securely inputting voice data into a system is needed, this invention can be used in connection to voice recognition technology whereby the data inputted into the system is protected from people in ear shot or from recording devices because the data spoken by the user is randomly generated corresponding data that changes each time the system is accessed thereby making any captured data useless to unauthorized users who may try to gain access or use the data in an unauthorized fashion such as identity theft.

What is claimed is:

1. A method and apparatus for securely inputting information into a web site or computing device comprising of the following:
a virtual input device that contains all the letters, numbers and or characters that the user may require that can look like a keyboard and that can be accessed by the user via mouse or pointing device, or by tab or arrow keys on a keyboard or mobile phone for instance, or a stylus on a hand held computing device or even via voice recognition or touch screen, the data can then be encrypted for storage or transmission, or displayed in regular or encrypted form such as asterisk or all of the above, while this is the core of the invention further elements can be added if desired for security enhancements or for particular applications but are not required.

2. A method according to claim 1 further comprising the following: The virtual input apparatus can pop-up on screen or on an independent window, or as part of the main screen, the keys on the virtual input apparatus can be scrambled each time the user accesses that page or screen to avoid patterns and the location on the screen can also be randomized to further obscure any patterns that may lead to unauthorized use.

3. A method according to claim 1 which may or may not utilize claim 2 further comprising the following: The virtual input device if desired can have additional security methods added in tandem such as obscuring graphically the keyboard image each time the device is accessed so as to defeat optical character recognition technology and also if desired, each letter can additionally have a corresponding number or other symbol on the same key that changes each time the device is accessed so that it can be used to further obscure patterns or be used with voice recognition software so that the user will say a number or symbol corresponding to the correct virtual key they want to activate thereby not revealing sensitive information to anyone that may be listening or divulging information to a recording device that may not be authorized and furthermore not being required to even touch the keyboard with a stylus, or click of a mouse or directional keys but with voice recognition can say the corresponding numbers to the key they want to activate.

4. A method according to claim 1 which may or may not utilize claims mentioned above or can use in any combination thereof or can be used in connection to other security systems that can or may not employ any of the above claims, or even be employed alone, a system whereby a software program freezes the operating systems ability to capture computer screen shots and or also detects other spyware that maybe have the ability to capture screen shots and bars their access to the inputted data.
